(19) United States
(12) Patent Application Publication
(10) Pub. No.: US 2023/0041201 A1
(43) Pub. Date: Feb. 9, 2023

(54) FLUID CYLINDER SLEEVE ASSEMBLY

(71) Applicant: SPM Oil & Gas Inc., Fort Worth, TX (US)

(72) Inventors: Jeff Myers, Fort Worth, TX (US); Richard David Peer, Fort Worth, TX (US)

(73) Assignee: SPM Oil & Gas Inc., Fort Worth, TX (US)

(21) Appl. No.: 17/791,762

(22) PCT Filed: Jan. 13, 2021
(86) PCT No.: PCT/US2021/013319

§ 371 Date: Jul. 8, 2022

Related U.S. Application Data
(60) Provisional application No. 62/960,640, filed on Jan. 13, 2020.

(51) Int. Cl. F04B 19/22; F16J 15/00; F16J 15/3284

(52) U.S. Cl. CPC F04B 19/22; F16J 15/002; F16J 15/3284

(57) ABSTRACT

A fluid cylinder for a fluid end section of a reciprocating pump is described. The fluid cylinder includes a body defining a pressure chamber in fluid communication with a plunger bore, the plunger bore comprising a packing segment configured to hold a packing stack, and a tubular sleeve in interference-fit within the plunger bore. The sleeve has an internal passage configured to accommodate a plunger operatively reciprocating within the plunger bore during operation of the reciprocating pump, and a stepped shoulder disposed at an interface between a first segment of the sleeve and a second segment of the sleeve, where a diameter of the first segment being greater than a diameter of the second segment of the sleeve. An annular seal is disposed at the stepped shoulder f the sleeve between the sleeve and the plunger bore. A packing flange is secured within the plunger bore abutting an end portion of the first segment of the sleeve.

### FIELD

The present disclosure relates to positive displacement pumps, and in particular, to a fluid cylinder sleeve assembly for positive displacement pumps.

### BACKGROUND

Hydraulic fracturing (a.k.a. fracking) is a process to obtain hydrocarbons such as natural gas and petroleum by injecting a fracking fluid or slurry at high pressure into a wellbore to create cracks in deep rock formations. The hydraulic fracturing process employs a variety of different types of equipment at the site of the well, including one or more positive displacement pumps, slurry blender, fracturing fluid tanks, high-pressure flow iron (pipe or conduit), wellhead, valves, charge pumps, and trailers upon which some equipment are carried.

Positive displacement pumps are commonly used in oil fields for high pressure hydrocarbon recovery applications, such as injecting the fracking fluid down the wellbore. A positive displacement pump typically has two sections, a power end and a fluid end. The power end includes a crankshaft powered by an engine that drives the plungers. The fluid end of the pump includes cylinders into which the plungers operate to draw fluid into the fluid chamber and then forcibly push out at a high pressure to a discharge manifold, which is in fluid communication with a well head. A seal assembly, also called a packing assembly or stuffing box, disposed in the cylinder chamber of the pump housing is used to prevent leakage of frac fluid from around the plunger during pumping operations.

### BRIEF DESCRIPTION OF THE DRAWINGS

FIG. 1 is a perspective view of an embodiment of a positive displacement pump according to the teachings of the present disclosure;

FIG. 2 is a partial cross-sectional side view of a sleeve assembly within a fluid cylinder; and

FIG. 3 is a more detailed partial cross-sectional side view of a sleeve assembly within a fluid cylinder.

### DETAILED DESCRIPTION

Certain embodiments of the disclosure provide a fluid cylinder for a fluid end section of a reciprocating pump includes a body having a pressure chamber and a plunger bore that fluidly communicates with the pressure chamber. The plunger bore includes a packing segment configured to hold packing. The fluid cylinder includes a sleeve received within the packing segment of the plunger bore. The sleeve is configured to hold a plunger within an internal passage of the sleeve such that the plunger is configured to reciprocate within the plunger bore during operation of the reciprocating pump. The fluid cylinder includes a retention mechanism secured within the plunger bore such that the retention mechanism is configured to retain the sleeve within the packing segment of the plunger bore.

Certain embodiments of the disclosure provide relatively inexpensive and reliable solutions for remedying washboarding and/or washout of a packing segment of a plunger bore of a reciprocating pump. Certain embodiments of the disclosure increase the longevity of a fluid cylinder of the reciprocating pump and thereby reduce operating costs of the reciprocating pump. Certain embodiments of the disclosure provide improved retention of a sleeve within a plunger bore of a reciprocating pump. Certain embodiments of the disclosure increase the longevity of the sleeve and/or reduce operating costs of the reciprocating pump. Certain embodiments of the disclosure increase the longevity of a seal between a sleeve and a plunger bore of a reciprocating pump and thereby reduce the operating costs of the reciprocating pump.

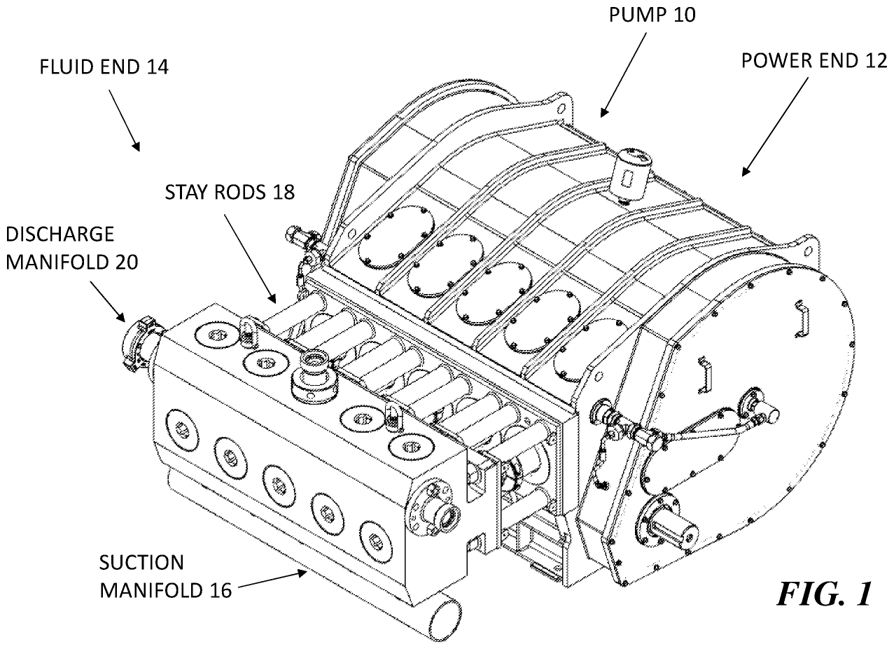

As shown in FIG. 1, the power end 12 of a positive displacement pump 10 uses a crankshaft that reciprocates a plunger rod assembly between the power end 12 and the fluid end 14. The fluid end section 14 includes a suction manifold 16 that is connected to a fluid source, and the fluid end 14 is connected to the housing via a plurality of stay rods 18. The crankshaft is powered by an engine or motor (not explicitly shown) that drives a series of plungers to create alternating high and low pressures inside a plurality of fluid cylinders. The plungers operate to draw the pump fluid into the fluid cylinders and then discharge the fluid at a high pressure to a discharge manifold 20. The discharged liquid is then injected at high pressure into an encased wellbore. The injected fracturing fluid is also commonly called a slurry, which is a mixture of water, abrasive proppants (silica sand or ceramic), and corrosive chemical additives. The pump 10 can also be used to inject a cement mixture down the wellbore for cementing operations. The pump may be freestanding on the ground, mounted to a skid, or mounted to a trailer.

In the power end 12, the crankshaft is typically mechanically connected to a motor. In one embodiment, a gear is mechanically connected to the crankshaft and is rotated by the motor through additional gears. A connecting rod connects to a crosshead through a crosshead pin, which holds the connecting rod longitudinally relative to the crosshead. The connecting rod is pivotally secured by a bushing within the crosshead, which holds the connecting rod longitudinally relative to the crosshead. The connecting rod pivots within the crosshead bushing as the crankshaft rotates with the other end of the connecting rod. A pony rod extends from the crosshead in a longitudinally opposite direction from the crankshaft. The connecting rod and the crosshead convert the rotational movement of the crankshaft into the longitudinal movement of the pony rod, which is connected to a plunger that draws and pushes the pump fluid passing through the cylinder housing. The plunger extends through a plunger bore and into a pressure chamber formed inside the fluid cylinder.

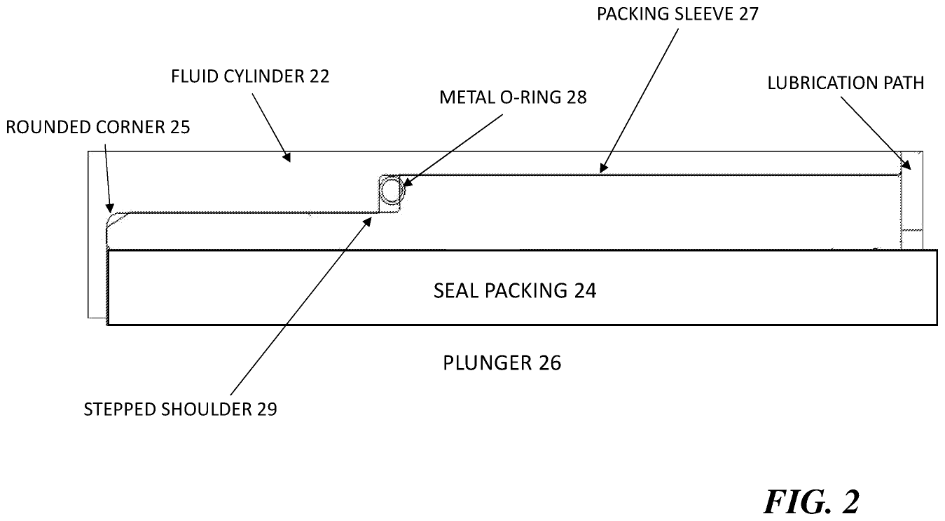

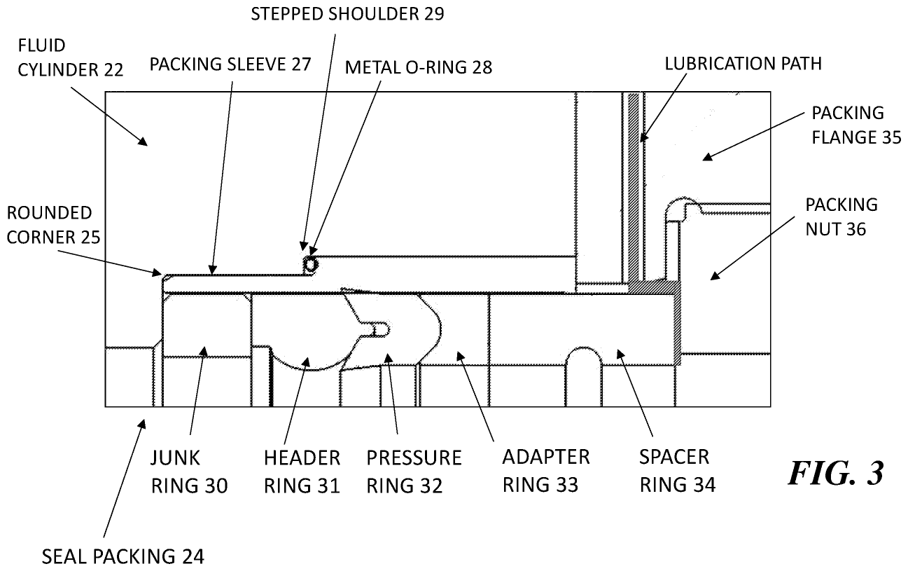

The fluid cylinder 22 of the pump 10 includes a body having a plunger bore that includes an inner wall and a seal assembly 24, as shown in FIG. 2. The seal assembly 24, also called a packing, a seal packing, a packing assembly, a packing stack, or stuffing box, is disposed in the cylinder chamber around the plunger 26 to prevent leakage of frac fluid from around the plunger during pumping operations. The seal packing assembly 24 may include multiple individual annular metallic and/or elastomer seal components 30-34 (FIG. 3) inserted into a stuffing box successively to form the packing during installation. This seal stack 24 is energized by a packing nut 36 that is also installed in machined contours and threading in the fluid end. The packing nut 36 preloads the seals to insure positive engagement with the plunger 26. A specific embodiment of the packing stack 24 includes, for example, a junk ring 30, a header ring 31, a pressure ring 32, an adapter ring 33, and a spacer ring 34, as shown in FIG. 3. To remedy washboarding and/or washout of the inner wall of the plunger bore, the fluid cylinder 22 incorporates a cylindrical packing sleeve 27 received between the packing assembly 24 and the inner wall of the plunger bore of the fluid cylinder 22.

The packing sleeve 27 includes a cylindrical internal passage that accommodates the plunger 26 as it reciprocates within the internal passage and the plunger bore, during operation of the reciprocating pump 10. The packing sleeve 27 includes an inner wall that defines the internal passage and the packing assembly 24 is received within the internal passage of the sleeve such that the packing 24 extends radially between an exterior surface of the plunger and the inner wall of the sleeve. The packing sleeve 27 holds the packing 24 within the internal passage of the sleeve 27 and the seal packing 24 in turn holds the plunger 26 within the internal passage. The packing 24 thereby seals the radial gap defined between the plunger 26 and the inner wall of the sleeve 27 to facilitate sealing the plunger 26 within the plunger bore of the fluid cylinder 22. The packing sleeve 27 may also incorporate a rounded corner 25 in its annular edge profile as shown in FIGS. 2 and 3. Further disposed between the packing sleeve 27 and the fluid cylinder 22 is a high-pressure metal seal or metal O-ring 28 that may comprise, for example, a face/split gland seal. The metal O-ring 28 is installed in an annular stepped shoulder 29 of the packing sleeve 27. The metal seal 28 may be, for example, an O-ring seal, C-ring, wave ring, or E-ring constructed of a metallic, non-metallic, or hybrid composite material. A lubrication path is disposed between the package flange 35 and the sleeve 27 to enable the conduction of a fluid to the seal packing 24.

Referring also to FIG. 3, the fluid cylinder 22 includes a retention mechanism that is used to secure the packing sleeve 27 within the plunger bore. The retention mechanism retains the sleeve 27 within the packing segment of the plunger bore and prevents the sleeve 27 from backing out of the plunger bore. The retention mechanism includes, for example, a packing flange 35 that can be secured to the fluid cylinder 22 using fasteners such as threaded bolts. The bolted flange 35 abuts the end portion of the sleeve 27 to retain the sleeve within the packing segment of the plunger bore. The use of the bolted packing flange 35 secures the packing sleeve 27 and decreases vibratory load shear. The bolted flange 35 is implemented on the packing side to increase the repairability of the fluid end because any thread issue would affect the flange 35 rather than the fluid cylinder 22. The bolted flange 35 provides axial load against the packing sleeve 27 independent of the packing nut 36. A hard shoulder 29 is introduced into the packing side of the fluid end where the metal seal 28 resides. The hard shoulder 29, unlike the movable packing nut 36, allows for an interference-fit directly between the sleeve 27, flange 35, and fluid cylinder 22. Specifically, the outer wall of the sleeve 27 is frictionally engaged with the inner wall of the plunger bore such that friction between the sleeve outer wall and the bore inner wall forms an interference-fit between the sleeve 27 and the packing segment 24 of the plunger bore. In some embodiments, the sleeve outer wall and/or the bore inner wall includes one or more barbs, textured areas (e.g., raised surfaces, patterned surfaces, etc.), protrusions, and/or the like that facilitates providing the interference-fit between the sleeve 27 and the packing segment 24 of the plunger bore. The axial interference-fit between the fluid cylinder 22 and the sleeve 27 further allows for the radial interference-fit to be reduced significantly. The axial interference-fit between the sleeve 27 and the fluid cylinder 22 may be different along different segments of the packing sleeve 27. For example, the interference-fit between the sleeve 27 and the fluid cylinder 22 may vary between 0.0 and 0.003 inches. Of course, the interference-fit can be more or less than this stated range depending on many factors.

The “step up” shoulder configuration 29 of the packing sleeve 27 reduces pressure force on sleeve 27 from the bore and also decreases cost in manufacturing. With the interference-fit between the sleeve 27 and the fluid cylinder 22, a more durable high-pressure seal or seal assembly 24 can be incorporated between the packing sleeve 27 and fluid cylinder 22. The seal packing configuration allows for the sleeve 27 to have a larger cross-sectional area beyond the metal seal 28, which reduces cost in manufacturing. If the seal 28 is at the same location axially as the first sealing point of the packing stack 24, it is optimal as a secondary seal.

In some embodiments, the sleeve body 27 is provided with anti-wear properties (e.g., strength, toughness, hardness, material consistency, etc.) to resist wear caused by washouts and/or washboarding. For example, in some embodiments the sleeve body 27 has a material hardness value that is selected to reduce wear caused by washouts and/or washboarding. Alternatively, the sleeve body 27 may be constructed of a softer material than the plunger 26 but has a hard durable surface coating (e.g., HVOC or tungsten carbide coating) on an inside diameter. Examples of metallic materials that can be selected to provide the sleeve with anti-wear properties include, but are not limited to, a steel (e.g., stainless steel, a hardened steel, etc.) a ceramic, tungsten cobalt, tungsten nickel, a tungsten carbide, tungsten carbide cobalt (e.g., tungsten carbide combined with approximately 6-10% cobalt, etc.), tungsten carbide nickel, zirconia, partially stabilized zirconia, titanium carbide, silicon nitride, sialon, a self-healing ceramic, a self-healing metal, a refractory material (e.g., oxides of aluminum, silicon, magnesium, etc.), and/or the like. Examples of non-metallic materials for the sleeve body includes filament-wound epoxy composites (including carbon fiber, nylon fiber, glass fiber, graphite fiber, etc.), epoxy, filled thermoplastic, filled plastic, etc.

The packing sleeve 27 is installed within the packing segment of the plunger bore using any suitable method, process, and/or the like, such as to provide an interference-fit between the sleeve and the packing segment. In one example, the sleeve is press-fit into the packing segment of the plunger bore such that the sleeve forms an interference-fit with the packing segment once fully received within the packing segment. The retention mechanism, e.g., the flange, is then installed abutting the end portion of the sleeve using fasteners that secure the flange onto the fluid cylinder.

The features of the present invention which are believed to be novel are set forth below with particularity in the appended claims. However, modifications, variations, and changes to the exemplary embodiments described above will be apparent to those skilled in the art, and the sleeve assembly for the packing bore described herein thus encompasses such modifications, variations, and changes and are not limited to the specific embodiments described herein.

What is claimed is:

1. A fluid cylinder for a fluid end section of a reciprocating pump, the fluid cylinder comprising:
a body defining a pressure chamber in fluid communication with a plunger bore, the plunger bore comprising a packing segment configured to hold a packing stack;
a tubular sleeve in interference-fit within the plunger bore, the sleeve having an internal passage configured to accommodate a plunger operatively reciprocating within the plunger bore during operation of the reciprocating pump;
the tubular sleeve having a stepped shoulder disposed at an interface between a first segment of the sleeve and a second segment of the sleeve, where a diameter of the first segment being greater than a diameter of the second segment of the sleeve;
an annular seal disposed at the stepped shoulder between the sleeve and the plunger bore; and
a packing flange secured within the plunger bore abutting an end portion of the first segment of the sleeve to retain the sleeve within the packing segment of the plunger bore.

2. The fluid cylinder of claim 1, wherein the packing stack comprises at least one sealing element selected from the group consisting of a junk ring, a header ring, a pressure ring, an adapter ring, and a spacer ring.

3. The fluid cylinder of claim 1, wherein the sleeve comprises a hard durable surface constructed of at least one of a material or coating selected from the group consisting of steel, a tungsten carbide composite, a non-ferrous metal, and a non-metallic composite material.

4. The fluid cylinder of claim 1, wherein the packing flange is bolted in place to the fluid cylinder.

5. The fluid cylinder of claim 1, wherein an end profile of the second segment of the sleeve having a rounded corner.

6. A fluid end section of a reciprocating pump, comprising:
a fluid cylinder defining a pressure chamber in fluid communication with a plunger bore;
a tubular sleeve disposed within the plunger bore of the fluid cylinder, the sleeve having an internal passage configured to accommodate a plunger operatively reciprocating within the internal passage during operation of the reciprocating pump;
the tubular sleeve having a stepped shoulder disposed at an interface between a first segment of the sleeve and a second segment of the sleeve, the first segment having a diameter greater than a diameter of the second segment of the sleeve;
a bolted flange secured within the plunger bore abutting an end portion of the tubular sleeve to retain the sleeve within the plunger bore.
a seal assembly disposed within the internal passage defined by the tubular sleeve; and
a packing nut abutting the seal assembly to energize the seal assembly.

7. The fluid end of claim 6, wherein the seal assembly comprises at least one sealing element selected from the group consisting of a junk ring, a header ring, a pressure ring, an adapter ring, and a spacer ring.

8. The fluid end of claim 6, further comprising an annular metal seal disposed at the stepped shoulder of the tubular sleeve.

9. The fluid end of claim 6, wherein the sleeve comprises a hard durable surface constructed of at least one of a material or coating selected from the group consisting of steel, a tungsten carbide composite, a non-ferrous metal, and a non-metallic composite material.

10. The fluid end of claim 6, further comprising a packing flange secured within the plunger bore abutting an end portion of the first segment of the sleeve to retain the sleeve within the packing segment of the plunger bore

11. The fluid end of claim 6, wherein an end profile of the second segment of the sleeve having a rounded corner.

12. A fluid cylinder for a fluid end section of a reciprocating pump, the fluid cylinder comprising:
a body defining a pressure chamber in fluid communication with a plunger bore, the plunger bore comprising a packing segment configured to hold a packing stack;
a tubular sleeve in interference-fit within the packing segment of the plunger bore, the sleeve having an internal passage configured to accommodate a plunger operatively reciprocating within the plunger bore during operation of the reciprocating pump;
an annular seal disposed at a stepped shoulder of the sleeve between the sleeve and the plunger bore; and
a packing flange secured within the plunger bore abutting an end portion of the sleeve to retain the sleeve within the packing segment of the plunger bore.

13. The fluid cylinder of claim 12, wherein the tubular sleeve comprises a hard durable surface constructed of at least one of a material or coating selected from the group consisting of steel, a tungsten carbide composite, a non-ferrous metal, and a non-metallic composite material.

14. The fluid cylinder of claim 12, wherein a stepped shoulder is disposed at an interface between a first segment of the sleeve and a second segment of the sleeve, the first segment having a diameter greater than a diameter of the second segment of the sleeve.

15. The fluid cylinder of claim 12, wherein the packing stack comprises at least one sealing element selected from the group consisting of a junk ring, a header ring, a pressure ring, an adapter ring, and a spacer ring.

16. The fluid cylinder of claim 12, wherein the packing flange is bolted in place to the fluid cylinder.

17. The fluid cylinder of claim 12, wherein an end profile of the second segment of the sleeve having a rounded corner.

18. The fluid cylinder of claim 12, further comprising a packing nut abutting the seal assembly to energize the packing stack.
